(19) United States
(12) Patent Application Publication
(10) Pub. No.: US 2025/0070247 A1
(43) Pub. Date: Feb. 27, 2025

(54) LITHIUM SECONDARY BATTERIES

(71) Applicant: SYENSQO SA, Brussels (BE)

(72) Inventors: Marc-David Braida, Bry-sur-Marne (FR); Jong-Hyun Lee, Hwaseong-si (KR); Hyun-Cheol Lee, Seoul (KR); Ji-Hye Won, Seoul (KR)

(73) Assignee: SYENSQO SA, Brussels (BE)

(21) Appl. No.: 18/723,809

(22) PCT Filed: Dec. 14, 2022
(86) PCT No.: PCT/EP2022/085898

§ 371 Date: Jun. 24, 2024

(30) Foreign Application Priority Data
Dec. 23, 2021 (EP) 21217536.8

(51) Int. Cl. H01M 10/0567; H01M 4/02; H01M 10/0525; H01M 10/0569

(52) U.S. Cl. CPC H01M 10/0567; H01M 10/0525; H01M 10/0569; H01M 2004/028; H01M 2300/0034

(57) ABSTRACT

The present invention pertains to a lithium secondary battery comprising a cathode comprising a lithium-manganese-rich layered oxide as a cathode electroactive material and a liquid electrolyte comprising at least one fluorinated acyclic carbonate. The present invention also relates to use of a liquid electrolyte comprising at least one fluorinated acyclic carbonate in a lithium secondary battery, for improving the cycling performance, comprising a cathode comprising a lithium-manganese-rich layered oxide as a cathode electroactive material according to the present invention.

### CROSS-REFERENCE TO RELATED APPLICATION

This application claims priority to European patent application No. 21217536.8 filed on Dec. 23, 2021, the whole content of this application being incorporated herein by reference for all purposes.

### TECHNICAL FIELD

The present invention pertains to a lithium secondary battery comprising a cathode comprising a lithium-manganese-rich layered oxide as a cathode electroactive material and a liquid electrolyte comprising at least one fluorinated acyclic carbonate. The present invention also relates to use of a liquid electrolyte comprising at least one fluorinated acyclic carbonate in a lithium secondary battery, for improving the cycling performance, comprising a cathode comprising a lithium-manganese-rich layered oxide as a cathode electroactive material according to the present invention.

### BACKGROUND OF THE INVENTION

Lithium secondary batteries have retained a dominant position in the market of rechargeable energy storage devices thanks to their many benefits comprising light-weight, reasonable energy density, and good cycle life.

Historically, lithium secondary batteries have drawn substantial attention since LiₓCoO₂ (0<x≤1) was first demonstrated by Goodenough et al. (Materials Research Bulletin 1980, Vol. 15, pp. 783-789) to have a relatively high energy density and good cycle stability, which was subsequently commercialized as a cathode electroactive material by SONY Corporation in the early 1990s. This discovery changed the paradigm of lithium secondary batteries.

The search for new high-performance and low-cost cathode electroactive materials has been always a challenging topic in this field. The development of electrochemical energy storage technology is critical not only for advancements in a variety of applications from consumer electronics to electrical vehicles (EVs), but also for the effective and controllable utilization of natural resources.

Accordingly, several approaches have been made to develop new cathode electroactive materials with higher energy density. Of particular focus have been always cathode electroactive materials, because the cathode electroactive materials constitute higher cost than anode electroactive materials.

With this purpose, various layered oxides with the formula LiMO₂ (M=Co, Mn and/or Ni) as well as spinel LiMn₂O₄ and olivine LiFePO₄ were considered. However, it was found that the low energy density of spinel LiMn₂O₄ and olivine LiFePO₄ limits their applications notably in large-scale EV and energy storage fields.

Subsequently, LiCoO₂ was found to have drawbacks such as low practical capacity and relatively high cost of Co; and hence a layered LiNiO₂ was proposed as an alternative solution. However, it was found that LiNiO₂ has poor thermal stability and its production is difficult due to the Li/Ni disorder, as a result of Li/Ni exchange in octahedral sites, notably when Ni content increases to high values, as it leads to a detrimental effect on Li diffusibility, cycling stability, first-cycle efficiency and overall electrode performance. Accordingly, another solution was required despite the low cost and high rechargeable capacity of LiNiO₂ in comparison with LiCoO₂.

Other layered oxides hence have been further investigated, e.g., a binary oxide, such as LiNi_{0.5}Mn_{0.5}O₂, which is a solid solution between LiNiO₂ and LiMnO₂, and a ternary oxide, such as LiCo_{1/3}Ni_{1/3}Mn_{1/3}O₂, among which LiCo_{1/3}Ni_{1/3}Mn_{1/3}O₂ showed the best electrochemical performance with high reversible capacity and became a promising cathode electroactive materials for high power lithium secondary batteries.

Nonetheless, the specific energy density of commercialized lithium ion batteries still cannot satisfy the demand from practical applications, which keeps increasing for high power applications such as EVs, hybrid electrical vehicles (HEVs), grid energy storage, etc.

As one of diverse research efforts to find an alternative solution to meet such an ever-increasing demand, Jiang et al. in Molecular Systems Design & Engineering, 2018, Vol. 3, pp. 748-803 (“Li- and Mn-rich layered oxide cathode materials for lithium-ion batteries: a review from fundamentals to research progress and applications”) proposed Li- and Mn-rich layered oxide (“LMRO”) cathode electroactive materials, represented by x[Li₂MnO₃]·(1−x)[LiMO₂] (M=Co, Ni, Mn, Fe, Cr, etc.), which is composed of two phases, i.e. a trigonal LiMO₂ phase (space group R3m) and a monoclinic Li₂MnO₃ phase (space group (C2/m), wherein Li₂MnO₃ phase can enhance the electrochemical capacity of the cathode because it transforms into an active LiMnO₂ phase after the first cycle. In short, there exists a synergic effect between said two phases so that it contributes to the higher electrochemical performance of the cathode electroactive materials. Moreover, LMRO cathode electroactive materials are economically competitive and environmentally compatible. Yet, several issues and challenges still need to be overcome for its commercialization, including unclear crystal structure, ambiguous reaction mechanism, fast voltage fading, and poor rate capability.

There is thus a continuous need for lithium secondary batteries having improved cycling performance including stability, reliability, low cost, etc, which may be met by using new cathode electroactive materials as introduced above, new anode electroactive materials, liquid electrolyte formulations compatible with newly-designed electroactive materials, etc.

### SUMMARY OF THE INVENTION

The present invention pertains to a lithium secondary battery comprising a) a cathode comprising, as a cathode electroactive material, a lithium transition metal oxide represented by the following formula (I)

Li_{[(2x+2)/(x+2)]}Mn_{[2x/(x+2)]}M_{[(2-2x)/(x+2)]}O₂ (I)
wherein 0<x<1 and M is a combination of elements represented by the general formula (II)

(NiₐMn_{b}Co_{c})_{1-d}M′_{d} (II)
wherein a+b+c=1; 0≤c≤0.1; 0≤d≤0.1; and M′ comprises at least one metal selected from the group consisting of Sc, Ti, V, Cr, Fe, Cu, Zn, Mg, Al, Sn, B, Ga, Sr, Ca, In, Si, Zr, La, P, Nb, and Ge; and
b) a liquid electrolyte comprising at least one fluorinated acyclic carbonate represented by the formula (III)

R¹—OC(O)O—R² (III)
wherein R¹ and R² represent an alkyl group respectively; the sum of carbon atoms in any of R¹ and R² is from 2 to 7; and at least one hydrogen in R¹ and/or R² is replaced by fluorine.

The cathode electroactive material according to the present invention corresponds to a lithium-manganese-rich layered transition metal oxide.

The present invention also pertains to use of a liquid electrolyte comprising at least one fluorinated acyclic carbonate in a lithium secondary battery, for improving the cycling performance, comprising a cathode comprising, as a cathode electroactive material, a lithium-manganese-rich layered transition metal oxide according to the present invention.

It was surprisingly found by the inventors that the above-mentioned technical problems can be solved by using a particular combination of a cathode having a lithium-manganese-rich transition metal oxide and a liquid electrolyte comprising at least one fluorinated acyclic carbonate according to the present invention.

### DETAILED DESCRIPTION OF THE INVENTION

### Definitions

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

The term “alkyl” is intended to denote saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups.

The term “aliphatic group” includes organic moieties characterized by straight or branched-chains, typically having between 1 and 18 carbon atoms. In complex structures, the chains may be branched, bridged, or cross-linked. Aliphatic groups include alkyl groups, alkenyl groups, and alkynyl groups.

In the present invention, the term “cut-off voltage” is intended to denote a prescribed lower-limit voltage at which the discharging is considered complete. The cut-off voltage is usually chosen so that the maximum useful capacity of the battery is achieved. The cut-off voltage is different from one battery to the other and highly dependent on the type of batteries, e.g., type of cathode or anode.

In the present invention, the term “anode” is intended to denote, in particular, the electrode of an electrochemical cell, where oxidation occurs during discharging.

In the present invention, the term “cathode” is intended to denote, in particular, the electrode of an electrochemical cell, where reduction occurs during discharging.

In the present invention, the nature of the “current collector” depends on whether the electrode thereby provided is either a cathode or anode. Should the electrode of the invention be a cathode, the current collector typically comprises, preferably consists of at least one metal selected from the group consisting of Aluminium (Al), Nickel (Ni), Titanium (Ti), and alloys thereof, preferably Al. Should the electrode of the invention be an anode, the current collector typically comprises, preferably consists of at least one metal selected from the group consisting of Lithium (Li), Sodium (Na), Zinc (Zn), Magnesium (Mg), Copper (Cu) and alloys thereof, preferably Cu.

In the present invention, the term “electroactive material” is intended to denote an electroactive material that is able to incorporate or insert into its structure and substantially release therefrom lithium ions during the charging phase and the discharging phase of a battery. The nature of the electroactive material will depend on whether it will be used to form a cathode or an anode. The electroactive materials can thus be selected from cathode electroactive materials and anode electroactive materials.

As used herein, the terminology “(Cₙ-Cₘ)” in reference to an organic group, wherein n and m are integers, respectively, indicates that the group may contain from n carbon atoms to m carbon atoms per group.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

Unless otherwise specified, in the context of the present invention the amount of a component in a composition is indicated as the ratio between the volume of the component and the total volume of the composition multiplied by 100, i.e., % by volume (vol %) or as the ratio between the weight of the component and the total weight of the composition multiplied by 100, i.e., % by weight (wt %). It is to be understood that both the foregoing general description and the following detailed description are exemplary and are intended to provide further explanation of the invention as claimed. Accordingly, various changes and modifications described herein will be apparent to those skilled in the art. Moreover, descriptions of well-known functions and constructions may be omitted for clarity and conciseness.

The present invention relates to a lithium secondary battery comprising
a) a cathode comprising, as a cathode electroactive material, a lithium transition metal oxide represented by the following formula (I)

Li_{[(2x-2)(x-2)]}Mn_{[2x/(x+2)]}M_{[(2-2x)/(x-2)]}O₂ (I)
wherein 0<x<1 and M is a combination of elements represented by the general formula (II)

(NiₐMn_{b}Co_{c})_{1-d}M′_{d} (II)
wherein a+b+c=1; 0≤c≤0.1; 0≤d≤0.1; and M′ comprises at least one metal selected from the group consisting of Sc, Ti, V, Cr, Fe, Cu, Zn, Mg, Al, Sn, B, Ga, Sr, Ca, In, Si, Zr, La, P, Nb, and Ge; and
b) a liquid electrolyte comprising at least one fluorinated acyclic carbonate represented by the formula (III)

R¹—OC(O)O—R² (III)
wherein R¹ and R² represent an alkyl group respectively; the sum of carbon atoms in any of R¹ and R² is from 2 to 7; and at least one hydrogen in R¹ and/or R² is replaced by fluorine.

In a preferred embodiment, 0.1≤x≤0.7.

In a more preferred embodiment, 0.3≤x≤0.55.

The cathode electroactive material according to the present invention corresponds to a lithium-manganese-rich layered oxide.

In one embodiment, the cathode electroactive material according to the present invention does not contain Co, i.e. c is zero.

In another embodiment, the cathode electroactive material contains more manganese than nickel, wherein a*(1−d)<[x/(1−x)]+b(1−d).

Non-limitative examples of suitable cathode electroactive materials according to the present invention include, notably the followings:
Li_{1.09}Mn_{0.91}O₂ (identical to 0.2[Li₂MnO₃]·0.8[LiMnO₂]), Li_{1.25}Mn_{0.625}Ni_{0.125}O₂, Li_{1.15}Mn_{0.56}Ni_{0.29}O₂ and Li_{1.17}Mn_{0.54}Ni_{0.28}O₂.

In a preferred embodiment, the cathode electroactive material is selected from the group consisting of Li_{1.15}Mn_{0.56}Ni_{0.29}O₂ and Li_{1.17}Mn_{0.54}Ni_{0.28}O₂.

In one embodiment, R¹ and R² contain neither a CH₂F— group nor a —CHF— group.

In one embodiment, the number of carbon atoms in R¹ in the formula (III) is 1, 2, 3, 4, or 5. In a preferred embodiment, the number of carbon atoms in R¹ in the formula (III) is 1.

In another particular embodiment, R¹ and R² independently represent a straight-chain or branched alkyl group having from 2 to 7 carbon atoms, where at least two hydrogens are replaced by fluorines. That is, at least two hydrogens in R¹ are replaced by fluorines, or at least two hydrogens in R² are replaced by fluorines, or at least two hydrogens in R¹ and at least two hydrogens in R² are replaced by fluorines.

Non-limitative examples of suitable fluorinated acyclic carbonate according to the present invention include, notably the followings:
CH₃—OC(O)O—CH₂CF₂H (methyl 2,2-difluoroethyl carbonate), CH₃—OC(O)O—CH₂CF₃ (methyl 2,2,2-trifluoroethyl carbonate), CH₃—OC(O)O—CH₂CF₂CF₂H (methyl 2,2,3,3-tetrafluoropropyl carbonate), CF₂HCH₂—OC(O)O—CH₂CF₃ (2,2-difluoroethyl 2,2,2-trifluoroethyl carbonate), CH₃CH₂—OC(O)O—CH₂CF₂H (ethyl 2,2-difluoroethyl carbonate), CF₃CH₂—OC(O)O—CH₂CH₃ (ethyl 2,2,2-trifluoroethyl carbonate), CF₃CH₂—OC(O)O—CH₂CF₃ (bis(2,2,2-trifluoroethyl) carbonate), CF₂HCH₂—OC(O)O—CH₂CF₂H (bis(2,2-difluoroethyl) carbonate), CF₃—OC(O)O—CF₃, CFH₂—OC(O)O—CH₃, CF₃CHF—OC(O)O—CF₃, CH₃CH₂—OC(O)O—CHFCH₃, CH₃CHF—OC(O)O—CHFCH₃, CH₃CHF—OC(O)O—CH₂CF₃, CH₃CHF—OC(O)O—CH₂CH₂CH₃, and mixtures thereof.

In a preferred embodiment, the fluorinated acyclic carbonate comprises CH₃—OC(O)O—CH₂CF₂H (methyl 2,2-difluoroethyl carbonate), CH₃—OC(O)O—CH₂CF₃ (methyl 2,2,2-trifluoroethyl carbonate), CH₃—OC(O)O—CH₂CF₂CF₂H (methyl 2,2,3,3-tetrafluoropropyl carbonate), CF₂HCH₂—OC(O)O—CH₂CF₃ (2,2-difluoroethyl 2,2,2-trifluoroethyl carbonate), CH₃CH₂—OC(O)O—CH₂CF₂H (ethyl 2,2-difluoroethyl carbonate), CF₃CH₂—OC(O)O—CH₂CH₃ (ethyl 2,2,2-trifluoroethyl carbonate), or mixtures thereof.

In a more preferred embodiment, the fluorinated acyclic carbonate is CH₃—OC(O)O—CH₂CF₃ (methyl 2,2,2-trifluoroethyl carbonate).

In one embodiment, the fluorinated acyclic carbonate is in an amount of from 10 to 50% by weight (wt %), preferably from 10 to 40 wt % and more preferably from 10 to 30 wt %, based on the total weight of the liquid electrolyte.

In another embodiment, b) the liquid electrolyte further comprises a fluorinated acyclic carboxylic acid ester represented by the formula (IV)

R³—C(O)O—R⁴ (IV)
wherein R³ and R⁴ represent an alkyl group respectively; the sum of carbon atoms in R³ and R⁴ is from 2 to 7; and R³ does not contain fluorine, and R⁴ contains at least one fluorine.

In a particular embodiment, R³ and R⁴ contain neither a CH₂F— group nor a —CHF— group.

In another particular embodiment, R³ and R⁴ independently represent a straight-chain or branched alkyl group having from 2 to 7 carbon atoms, where at least two hydrogens are replaced by fluorines. That is, at least two hydrogens in R⁴ are replaced by fluorines.

Non-limitative examples of suitable fluorinated acyclic carboxylic acid ester according to the present invention include, notably, the followings:
CH₃—C(O)O—CH₂CF₂H, CH₃—C(O)O—CF₂H, CH₃—C(O)O—CF₂CF₃, CH₃—C(O)O—CH₂CF₃, CH₃—C(O)O—CF₃, CH₃—C(O)O—CF₂CF₂CF₃, (CH₃)₂CH—C(O)O—CF₃, CH₃CH₂—C(O)O—CF₂H, CH₃CH₂—C(O)O—CF₃, CH₃CH₂—C(O)O—CF₂CH₃, CH₃—C(O)O—CH(CF₃) CH₃, CH₃CH₂—C(O)O—CH₂CF₂H, CH₃—C(O)O—CH₂CH₂CF₂H, CH₃—C(O)O—CH₂CF₂CF₂H, CH₃CH₂—C(O)O—CH₂CH₂CF₂H, CH₃—C(O)O—CF₂CF₂H, CH₃—C(O)O—CF₂CF₂CF₂CF₂H, CH₃CH₂CH₂—C(O)O—CH₂CF₃, CH₃—C(O)O—CH₂CH₂CH₂CF₂CF₃, (CH₃)₂CH—C(O)O—CH₂CF₂H, CH₃CH₂CH₂—C(O)O—CF₂H, (CH₃)₂CH—C(O)O—CF₂H, CH₃CH₂—C(O)O—CH₂CF₃, and mixtures thereof.

In a preferred embodiment, the fluorinated acyclic carboxylic acid ester is CH₃—C(O)O—CH₂CF₂H (2,2-difluoroethyl acetate).

In another embodiment, b) the liquid electrolyte further comprises at least one fluorinated acyclic diether represented by the formula (V)

R⁵—O—R⁶—O—R⁷ (V)

wherein R⁵ and R⁷ represent a fluorinated straight-chain alkyl group respectively; R⁶ represents an optionally fluorinated straight-chain alkyl group; and the sum of carbon atoms in R⁵, R⁶, and R⁷ is from 5 to 8, and preferably 6.

In one embodiment, the boiling point of the fluorinated acyclic diether is at least 80° C., preferably from 80° C. to 160° C., and more preferably from 120° C. to 160° C.

In one embodiment, the molar ratio F/H in the fluorinated acyclic diether is from 1.3 to 13.0, preferably from 2.5 to 6.0.

In a preferred embodiment, the fluorinated acyclic diether contains 6 carbon atoms.

In a more preferred embodiment, the fluorinated acyclic diether is CHF₂CF₂—O—CH₂CH₂—O—CF₂CF₂H.

Non-limitative examples of suitable fluorinated acyclic diether according to the present invention include, notably the followings:
CF₃CH₂—O—CF₂CHF—O—CF₃, CHF₂CH₂—O—CF₂CF₂—O—CF₃, CF₃CF₂—O—CHFCHF—O—CHF₂, CHF₂CF₂—O—CHFCHF—O—CF₃, CF₃CHF—O—CHFCF₂—O—CHF₂, CF₃CHF—O—CF₂CHF—O—CHF₂, CH₃CF₂—O—CF₂—O—CF₂CF₃, CFH₂CHF—O—CF₂—O—CF₂CF₃, CF₃CF₂—O—CHF—O—CHFCHF₂, CF₃CH₂—O—CF₂CF₂—O—CF₃, CHF₂CHF—O—CF₂CF₂—O—CF₃, CH₂FCF₂—O—CF₂CF₂—O—CF₃, CF₃CF₂—O—CHFCHF—O—CF₃, CF₃CF₂—O—CF₂CH₂—O—CF₃, CF₃CF₂—O—CH₂CF₂—O—CF₃, CF₃CF₂—O—CF₂CFH—O—CHF₂, CF₃CHF—O—CHFCF₂—O—CF₃, CF₃CHF—O—CF₂CHF—O—CF₃, CHF₂CF₂—O—CF₂CHF—O—CF₃, CHF₂CF₂—O—CHFCF₂—O—CF₃, CHF₂CF₂—O—CF₂CF₂—O—CHF₂, CF₃CHF—O—CF₂CF₂—O—CHF₂, CF₃CF₂—O—CF₂—O—CHFCF₃, CF₂HCF₂—O—CF₂—O—CF₂CF₃, CF₃CHF—O—CF₂—O—CF₂CF₃, CF₃CF₂—O—CHF—O—CF₂CF₃, CF₃CF₂—O—CF₂—O—CF₂CHF₂, CF₂HCF₂—O—CF₂CH₂—O—CF₂CF₂H, CF₃CF₂—O—CH₂CH₂—O—CF₂CF₃, CF₂HCF₂—O—CHFCHF—O—CF₂CF₂H, CF₃CF₂—O—CHFCH₂—O—CF₂CF₂H, CF₃CF₂—O—CH₂CHF—O—CF₂CF₂H, CF₃—O—CHFCF₂CH₂—O—CF₂CF₂H, CF₂HCF₂—O—CF₂CF₂—O—CF₂CF₂H, CF₃CF₂—O—CF₂CHF—O—CF₂CF₂H, CF₃CF₂—O—CHFCF₂—O—CF₂CF₂H, CF₃CF₂—O—CF₂CH₂—O—CF₂CF₃, CF₃CF₂—O—CHFCHF—O—CF₂CF₃, and mixtures thereof.

In another embodiment, the fluorinated acyclic diether contains 7 carbon atoms.

In another embodiment, the fluorinated acyclic diether contains 8 carbon atoms.

In one embodiment, b) the liquid electrolyte according to the present invention comprises neither a non-fluorinated ether nor a fluorinated mono-ether.

In the present invention, the term “non-fluorinated ether” is intended to denote an ether compound, wherein no fluorine atom is present.

In the present invention, the term “fluorinated mono-ether” is intended to denote a mono-ether compound, wherein at least one hydrogen atom is replaced by fluorine. One, two, three or a higher number of hydrogen atoms may be replaced by fluorine.

The liquid electrolyte according to the present invention does not comprise a fluorinated cyclic carboxylic acid ester, e.g., a fluorinated lactone containing a 1-oxacycloalkan-2-one structure.

In one embodiment, b) the liquid electrolyte further comprises at least one organic carbonate.

In the present invention, the organic carbonate comprises a fluorinated cyclic carbonate, a non-fluorinated cyclic carbonate and a non-fluorinated acyclic carbonate.

Non-limitative examples of the organic carbonate according to the present invention include, notably the followings:
4-fluoroethylene carbonate (4-fluoro-1,3-dioxolan-2-one), 4,5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, 4-fluoromethyl-1,3-dioxolan-2-one, tetrafluoroethylene carbonate, 4-(2,2-difluoroethoxy)ethylene carbonate, 4-(2,2,2-trifluoroethoxy)ethylene carbonate, ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, bisphenol A, B and F carbonate, dimethyl carbonate, ethyl methyl carbonate, diethyl carbonate, and mixtures thereof.

In a particular embodiment, the organic carbonate is a mixture of fluoroethylene carbonate, propylene carbonate and ethylene carbonate.

In another particular embodiment, the organic carbonate is a mixture of fluoroethylene carbonate and propylene carbonate.

In the present invention, the total amount of the at least one organic carbonate is from 0 to 90 wt %, preferably from 0 to 80 wt %, more preferably from 0 to 60 wt %, and most preferably 0 to 50 wt % with respect to the total weight of the liquid electrolyte.

The total amount of the at least one organic carbonate, if contained in the liquid electrolyte of the present invention, is from 10 to 80 wt %, preferably from 20 to 60 wt %, and more preferably from 25 to 50 wt % with respect to the total weight of the liquid electrolyte.

In one embodiment, b) the liquid electrolyte further comprises at least one lithium salt.

Non-limitative examples of the lithium salt according to the present invention include, notably the followings:
a lithium ion complex such as lithium hexafluorophosphate (LiPF₆), lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, LiBF₂[O₂C(CX₂)ₙCO₂], LiPF₂[O₂C(CX₂)ₙCO₂]₂, LiPF₄[O₂C(CX₂)ₙCO₂] wherein X is selected from the group consisting of H, F, Cl, C₁-C₄ alkyl groups and fluorinated alkyl groups, and n=0-4, lithium trifluoromethane sulfonate (LiCF₃SO₃), lithium bis(fluorosulfonyl)imide Li(FSO₂)₂N (LiFSI), LiN(SO₂CₘF_{2m·1})(SO₂CₙF₂ₙ₊₁) and LiN(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiN(SO₂CₚF₂ₚSO₂)(SO₂C_{q}F_{2q+1}) wherein p=1-10 and q=1-10, and mixtures thereof.

In one embodiment, the lithium salt is lithium bis(trifluoromethanesulfonyl)imide (LiN(CF₃SO₂)₂; LiTFSI).

In another embodiment, the lithium salt is LiPF₆.

In the other embodiment, the lithium salt is LiFSI.

In one embodiment, a molar concentration (M) of the lithium salt in the liquid electrolyte according to the present invention is from 1 M to 8 M, preferably from 1 M to 4 M, and more preferably from 1 M to 2 M.

The lithium salt according to the present invention does not comprise lithium salts having nitrogen atoms on a heterocyclic ring such as an imidazole, e.g., lithium 2-trifluoromethyl-4,5-dicyanoimidazole (LiTDI).

According to one embodiment, the liquid electrolyte according to the present invention further comprises at least one film-forming additive, which promotes the formation of the solid electrolyte interface (SEI) layer at the negative electrode surface by reacting in advance of the solvents on the electrode surfaces. For the SEI layer, the main components hence comprise the decomposed products of electrolyte solvents and salts, which may include Li₂CO₃, lithium alkyl carbonate, lithium alkyl oxide and other salt moieties such as LiF for LiPF₆-based electrolytes. According to another embodiment, the film-forming additive stabilizes the cathode electrolyte interface (CEI) layer at the positive electrode surface by preventing the structural change of the positive electrode, notably under high voltage. Usually, the reduction potential of the film-forming additive is higher than that of the solvent when a reaction occurs at the negative electrode surface, and the oxidation potential of the film-forming additive is lower than that of the solvent when the reaction occurs at the positive electrode side.

In the present invention, the film-forming additive is different from the lithium salt.

In a particular embodiment, the film-forming additive according to the present invention is selected from the group consisting of sulfur compounds comprising 1,3,2-dioxathiolane-2,2-dioxide, 1,3,2-dioxathiolane-4-ethynyl-2,2-dioxide, 1,3,2-dioxathiolane-4-ethenyl-2,2-dioxide, 1,3,2-dioxathiolane-4,5-diethenyl-2,2-dioxide, 1,3,2-dioxathiolane-4-methyl-2,2-dioxide, 1,3,2-dioxathiolane-4,5-dimethyl-2,2-dioxide, 1,3,2-dioxathiane-2,2-dioxide, 1,3,2-dioxathiane-4-ethynyl-2,2-dioxide, 1,3,2-dioxathiane-5-ethynyl-2,2-dioxide, 1,3,2-dioxathiane-4-ethenyl-2,2-dioxide, 1,3,2-dioxathiane-5-ethenyl-2,2-dioxide, 1,3,2-dioxathiane-4,5-diethenyl-2,2-dioxide, 1,3,2-dioxathiane-4,6-diethenyl-2,2-dioxide, 1,3,2-dioxathiane-4,5,6-triethenyl-2,2-dioxide, 1,3,2-dioxathiane-4-methyl-2,2-dioxide, 1,3,2-dioxathiane-5-methyl-2,2-dioxide, 1,3,2-dioxathiane-4,5-dimethyl-2,2-dioxide, dioxathiane-4,6-dimethyl-2,2-dioxide, dioxathiane-4,5,6-trimethyl-2,2-dioxide; 1,3-propane sultone, 1-fluoro-1,3-propane sultone, 2-fluoro-1,3-propane sultone, 3-fluoro-1,3-propane sultone, 1,4-butane sultone, 3-fluoro-1,4-butane sultone, 4-fluoro-1,4-butane sultone, 5-fluoro-1,4-butane sultone, 6-fluoro-1,4-butane sultone, preferably 1,3,2-dioxathiolane-2,2-dioxide, 1,3,2-dioxathiane-2,2-dioxide, 1,2-oxathiolane-2,2-dioxide (1,3-propane sultone), 1,3,2-dioxathiolane-2-oxide (ethylene sulfite) and prop-1-ene-1,3-sultone, dimethyl sulfone, tetramethylene sulfone (also known as sulfolane), ethyl methyl sulfone and isopropyl methyl sulfone; nitrile derivatives comprising succinonitrile, adiponitrile, and glutaronitrile; lithium nitrate (LiNO₃); boron derivatives salt comprising lithium difluoro oxalato borate (LiDFOB), lithium bis(oxalato)borate (LiB(C₂O₄)₂; LiBOB), lithium fluoromalonato (difluoro) borate (LiB(O₂CCHFCO₂)₂; LiFMDFB), lithium bis(malonato)borate [LiB(O₂CCH₂CO₂)₂], lithium bis(difluoromalonato)borate [LiB(O₂CCF₂CO₂)₂], lithium (malonatooxalato) borate [LiB(C₂O₄)(O₂CCH₂CO₂)], lithium (difluoromalonatooxalato) borate [LiB(C₂O₄)(O₂CCF₂CO₂)], lithium tris(oxalato) phosphate [LiP(C₂O₄)₃], lithium tris(difluoromalonato)phosphate [LiP(O₂CCF₂CO₂)₃], lithium difluorophosphate (LiPO₂F₂), vinyl acetate, biphenyl benzene, isopropyl benzene, hexafluorobenzene, tris(trimethylsilyl)phosphate, triphenyl phosphine, ethyl diphenylphosphinite, triethyl phosphite, tris(2,2,2-trifluoroethyl) phosphite, maleic anhydride, vinylene carbonate, vinyl ethylene carbonate, cesium bis(trifluoromethanesulfonyl)imide (CsTFSI), cesium hexafluorophosphate (CsPF₆), cesium fluoride (CsF), trimethylboroxine (TMB), tributyl borate (TBB), 2-(2,2,3,3,3-pentafluoropropoxy)-1,3,2-dioxaphospholane (PFPOEPi), 2-(2,2,3,3,3-pentafluoropropoxy)-4-(trifluormethyl)-1,3,2-dioxaphospholane (PFPOEPi-1CF₃), lithium hexafluorophosphate (LiPF₆), silver nitrate (AgNO₃), silver hexafluorophosphate (AgPF₆), tris(trimethylsilyl)phosphine (TMSP), 1,6-divinylperfluorohexane, and mixtures thereof.

In a preferred embodiment, the film-forming additive is selected from the group consisting of sulfur compounds comprising 1,3,2-dioxathiolane-2,2-dioxide, 1,3,2-dioxathiane-2,2-dioxide, 1,3-propanesultone, ethylene sulphite and prop-1-ene-1,3-sultone; sulfone derivatives comprising dimethyl sulfone, tetramethylene sulfone (also known as sulfolane), ethyl methyl sulfone and isopropyl methyl sulfone; nitrile derivatives comprising succinonitrile, adiponitrile, and glutaronitirle; and lithium nitrate (LiNO₃); boron derivatives salt comprising lithium difluoro oxalato borate (LiDFOB), lithium bis(oxalato) borate (LiB(C₂O₄)₂; LiBOB), lithium fluoromalonato (difluoro) borate (LiB(O₂CCHFCO₂)₂; LiFMDFB), lithium bis(malonato)borate [LiB(O₂CCH₂CO₂)₂], lithium bis(difluoromalonato) borate [LiB(O₂CCF₂CO₂)₂], lithium (malonatooxalato) borate [LiB(C₂O₄)(O₂CCH₂CO₂)], lithium (difluoromalonatooxalato) borate [LiB(C₂O₄)(O₂CCF₂CO₂)], lithium tris(oxalato) phosphate [LiP(C₂O₄)₃], lithium tris(difluoromalonato) phosphate [LiP(O₂CCF₂CO₂)₃], lithium difluorophosphate (LiPO₂F₂), vinyl acetate, biphenyl benzene, isopropyl benzene, hexafluorobenzene, tris(trimethylsilyl)phosphate, triphenyl phosphine, ethyl diphenylphosphinite, triethyl phosphite, tris(2,2,2-trifluoroethyl) phosphite, maleic anhydride, cesium bis(trifluoromethanesulfonyl)imide (CsTFSI), cesium fluoride (CsF), and mixtures thereof.

In a more preferred embodiment, the film-forming additive according to the present invention is LiBOB.

In another more preferred embodiment, the film-forming additive according to the present invention is LiDFOB.

In a particular embodiment, the film-forming additive according to the present invention is an ionic liquid.

The term “ionic liquid” as used herein refers to a compound comprising a positively charged cation and a negatively charged anion, which is in the liquid state at the temperature of 100° C. or less under atmospheric pressure. While ordinary liquids such as water are predominantly made of electrically neutral molecules, ionic liquids are largely made of ions and short-lived ion pairs. As used herein, the term “ionic liquid” indicates a compound free from solvent.

Non-limitative examples of the ionic liquid according to the present invention include, notably, N-methyl-N-propylpyrrolidinium bis(fluorosulfonyl) imide (PYR13FSI), N-butyl-N-methylpyrrolidinium bis(fluorosulfonyl) imide (PYR14FSI), N-methyl-N-propylpyrrolidinium bis(trifluoromethanesulfonyl) imide (PYR13TFSI), and N-butyl-N-methylpyrrolidinium bis(trifluoromethanesulfonyl) imide (PYR14TFSI).

In the present invention, the total amount of the film-forming additive may be from 0 to 10 wt %, preferably from 0 to 8 wt %, and more preferably from 0 to 5 wt % with respect to the total weight of the liquid electrolyte.

The total amount of the film-forming additive, if contained in the liquid electrolyte of the present invention, is from 0.05 to 5.0 wt %, and preferably from 0.05 to 3.0 wt %, with respect to the total weight of the liquid electrolyte.

In a particular embodiment, the total amount of the film-forming additive accounts for at least 1.0 wt % of the liquid electrolyte.

According to one embodiment, the liquid electrolyte according to the present invention may further comprise at least one HF scavenger. HF that is generated by hydrolysis of a lithium salt, for instance LiPF₆, may dissolve transition metal components in the interface between cathode and electrolyte; negatively affect the stability of SEI layers that protect the electrodes upon repeated cycling; promote the leaching of SEI components; and facilitating electrolyte decomposition at the reactive electrode. This eventually results in poor cycling lifetime of the cathode electroactive materials.

In particular, in case of a Si-based anode, the presence of a HF scavenger is of much higher importance to obtain a high performance batteries, because the generation of HF negatively affects the reliability of SEI layer on the surface of Si-based anode.

In a preferred embodiment, the HF scavenger is a nitrile compound, e.g. adiponitrile (AN), succinonitrile (SN), hexane tri-cyanide (1,3,6-HTCN), etc.

In the case of forming an anode for a lithium secondary battery, the anode electroactive material is not particularly limited and may comprise:
graphitic carbons able to intercalate lithium, typically existing in forms such as powders, flakes, fibers or spheres (e.g., mesocarbon microbeads) hosting lithium;
lithium metal;
lithium alloy compositions, including notably those described in U.S. Pat. No. 6,203,944 (3M Innovative Properties Co.) and WO 2000/03444 (Minnesota Mining & Manufacturing Co.);
lithium titanates, generally represented by formula Li₄Ti₅O₁₂: these compounds are generally considered as “zero-strain” insertion materials, having low level of physical expansion upon taking up the mobile ions, i.e. Li⁺;
lithium-silicon alloys, generally known as lithium silicides with high Li/Si ratios, in particular lithium silicides of formula Li_{4.4}Si;
lithium-germanium alloys, including crystalline phases of formula Li_{4.4}Ge;
silicon; and
silicon-carbon composite.

In one embodiment, the anode comprises silicon or silicon-carbon composite as the anode electroactive material.

The present invention also relates to use of a liquid electrolyte comprising at least one fluorinated acyclic carbonate represented by the formula (III)

R¹—OC(O)O—R² (III)
wherein R¹ and R² represent an alkyl group respectively; the sum of carbon atoms in any of R¹ and R² is from 2 to 7; and at least one hydrogen in R¹ and/or R² is replaced by fluorine,
in a lithium secondary battery, for improving the cycling performance, a lithium transition metal oxide represented by the formula (I) as a cathode electroactive material

Li_{[(2x+2)/(x+2)]}Mn_{[2x/(x+2)]}M_{[(2-2x)/(x+2)]}O₂ (I)
wherein 0<x<1 and M is a combination of elements represented by the general formula (II)

(NiₐMn_{b}Co_{c})_{1-d}M′_{d} (II)
wherein a+b+c=1; 0≤c≤0.1; 0≤d≤0.1; and M′ comprises at least one metal selected from the group consisting of Sc, Ti, V, Cr, Fe, Cu, Zn, Mg, Al, Sn, B, Ga, Sr, Ca, In, Si, Zr, La, P, Nb, and Ge.

In a preferred embodiment, 0.1≤x≤0.7.

In a more preferred embodiment, 0.3≤x≤0.55.

In one embodiment, the liquid electrolyte comprises
from 10 to 50 wt %, preferably from 10 to 40 wt %, and more preferably from 10 to 30 wt % of a fluorinated acyclic carbonate; and
from 10 to 80 wt %, preferably from 20 to 60 wt %, and more preferably from 25 to 50 wt % of at least one organic carbonate.

In a particular embodiment, the fluorinated acyclic carbonate is CH₃—OC(O)O—CH₂CF₃ (methyl 2,2,2-trifluoroethyl carbonate).

In one embodiment, the liquid electrolyte comprises a mixture of a fluorinated acyclic carbonate, a fluorinated acyclic diether and an organic carbonate.

In another embodiment, the liquid electrolyte comprises a mixture of a fluorinated acyclic carbonate, a fluorinated acyclic carboxylic acid ester, a fluorinated acyclic diether and an organic carbonate.

In the other embodiment, the liquid electrolyte comprises a mixture of a fluorinated acyclic carbonate, fluorinated acyclic carboxylic acid ester and an organic carbonate.

In a preferred embodiment, the liquid electrolyte for lithium secondary batteries according to the present invention comprises
CH₃—OC(O)O—CH₂CF₃ (methyl 2,2,2-trifluoroethyl carbonate) as a fluorinated acyclic carbonate;
CH₃—C(O)O—CH₂CF₂H (2,2-difluoroethyl acetate) as a fluorinated acyclic carboxylic acid ester;
—CF₂HCF₂—O—CH₂CH₂—O—CF₂CF₂H as a fluorinated acyclic diether;
a mixture of PC, FEC and/or EC as an organic carbonate;
1M of LiPF₆ as a lithium salt;
AN, SN and/or 1,3,6-HTCN as a HF scavenger; and
LiDFOB as a film-forming additive.

In another preferred embodiment, the liquid electrolyte for lithium secondary batteries according to the present invention comprises
CH₃—OC(O)O—CH₂CF₃ (methyl 2,2,2-trifluoroethyl carbonate) as a fluorinated acyclic carbonate;
—CF₂HCF₂—O—CH₂CH₂—O—CF₂CF₂H as a fluorinated acyclic diether;
a mixture of PC, FEC and/or EC as an organic carbonate;
1M of LiPF₆ as a lithium salt;
AN, SN and/or 1,3,6-HTCN as a HF scavenger; and
LiDFOB as a film-forming additive.

In the other preferred embodiment, the liquid electrolyte for lithium secondary batteries according to the present invention comprises
CH₃—OC(O)O—CH₂CF₃ (methyl 2,2,2-trifluoroethyl carbonate) as a fluorinated acyclic carbonate;
CH₃—C(O)O—CH₂CF₂H (2,2-difluoroethyl acetate) as a fluorinated acyclic carboxylic acid ester;
a mixture of PC, FEC and/or EC as an organic carbonate;
1M of LiPF₆ as a lithium salt;
AN, SN and/or 1,3,6-HTCN as a HF scavenger; and
LiDFOB as a film-forming additive.

In a particular embodiment, the lithium secondary battery according to the present invention comprises:
a silicon or silicon-carbon composite as an anode electroactive material;
a lithium-manganese-rich layered oxide as a cathode electroactive material according to the present invention;
a separator; and
a liquid electrolyte according to the present invention.

Should the disclosure of any patents, patent applications, and publications that are incorporated herein by reference conflict with the description of the present application to the extent that it may render a term unclear, the present description shall take precedence.

The invention will be now explained in more detail with reference to the following examples, whose purpose is merely illustrative and not intended to limit the scope of the invention.

### Examples

### Raw Materials

FEC: 4-fluoro-1,3-dioxolan-2-one, commercially obtained from Soulbrain;
EMC: ethyl methyl carbonate, commercially obtained from Enchem;
SA024: fluorinated acyclic carbonate of methyl 2,2,2-trifluoroethyl carbonate, i.e. CH₃—OC(O)O—CH₂CF₃, synthesized within Solvay;
LiBOB: a film-forming additive of lithium bis(oxalato) borate, commercially obtained from Enchem; and
LiPF₆: a Li salt of lithium hexafluorophosphate, commercially obtained from Enchem.

### A/ Formulation of the Liquid Electrolyte:

The liquid electrolytes were prepared for the Inventive Example of E1 and Comparative Example of CE1, wherein 1 M of LiPF₆ was used as a Li salt and 0.5 wt % of LiBOB was incorporated as a film-forming additive with respect to the total weight of the liquid electrolyte. Their constituents are summarized in Table 1 below:

TABLE 1

| | Fluorinated acyclic carbonate | Organic carbonate |
|---|---|---|
| E1 | SA024 (12)* | FEC/EMC (30/58)* |
| CE1 | — | FEC/EMC (30/70)* |

*wt % with respect to the total weight of the liquid solvent

When preparing the liquid electrolyte of E1, 30 wt % of FEC, 58 wt % of EMC and 12 wt % of SA024 were first mixed under stirring to form a liquid solvent, and subsequently 0.5 wt % of LiBOB was introduced thereto using a magnetic stirrer until the solution became transparent. Lastly, 1 M of LiPF₆ was dissolved in the solution.

The liquid electrolyte of CE1 was prepared in the same manner as E1, except that SA024 was not incorporated.

All electrolyte preparation steps were performed at a glove box.

### B/ Coin Cell Preparation

For the electrolyte test, the cathode, anode, and separator were prepared. Cathode electroactive material, i.e. NM13 of Li_{1.2}Ni_{0.2}Mn_{0.6}O₂, was prepared by co-precipitation. The cathode consisted of NM13, carbon black, and PVDF binder (polyvinilidene difluoride; SOLEF®5130 commercially available from Solvay Specialty Polymers Italy), the ratio was 95/3/2 wt %. The anode consisted of artificial graphite, carbon black, and PVDF binder, the ratio was 90/4/6 wt %. Polyethylene porous film was used as a separator.

The electrolyte test was performed by the coin cells. All coin parts, CR2032 specification, were commercially available from Wellcos. The test components of coin cells were the cathode electrode, anode electrode, and separator. Each element was first cut by a circle disc, which disc size was that the cathode was Φ15, the anode was Φ16, and the separator was Φ19. Subsequently, the elements were dried under vacuum overnight, i.e. at 100° C. for the electrodes and 60° C. for the separator. After drying, all components were moved to a glove box, and the coin cells were assembled. The separator was located between the cathode and the anode, and the electrolyte was injected with separator. After sealing, the cells were kept at 25° C. for 24 hours. Cells were cycled between 2.0 and 4.7 V at 25° C. by using a PEBC050.1 cycler from WONIK PNE Co. Ltd. to perform SEI formation. Cells were charged and discharged at a rate of C/10 for 3 cycles.

### C/ Cell Evaluation Procedure

Cycling at 25° C.: Cells with NM13 were maintained at 25±0.1° C. and cycled at 0.33C charge/0.33C discharge between 2.0 and 4.7 V.

### D/ Results

The cycle retention of the liquid electrolytes E1 and CE1 at room temperature (25° C.) is shown in Table 2 below.

TABLE 2

| | Cycle number of 80% retention (25° C.) |
|---|---|
| E1 | 87 cycles |
| CE1 | 55 cycles |

Liquid electrolyte according to the invention E1 showed excellent cycling performance at 25° C., much higher than CE1. In particular, CE1, i.e. liquid electrolyte containing only organic carbonates without fluorinated acyclic carbonate showed inferior cycle retention than E1.

In a nutshell, it was clearly demonstrated that the liquid electrolytes according to the invention E1 provides higher capacity retention than the liquid electrolyte of CE1.

1. A lithium secondary battery comprising
a) a cathode comprising, as a cathode electroactive material, a lithium transition metal oxide represented by the following formula (I)
Li_{[(2x+2)/(x+2)]}Mn_{[2x/(x+2)]}M_{[(2-2x)/(x+2)]}O₂ (I)
wherein 0<x<1 and M is a combination of elements represented by the general formula (II)
(NiₐMn_{b}Co_{c})_{1-d}M′_{d} (II)
wherein a+b+c=1; 0≤c≤0.1; 0≤d≤0.1; and M′ comprises at least one metal selected from the group consisting of Sc, Ti, V, Cr, Fe, Cu, Zn, Mg, Al, Sn, B, Ga, Sr, Ca, In, Si, Zr, La, P, Nb, and Ge; and
b) a liquid electrolyte comprising at least one fluorinated acyclic carbonate represented by the formula (III)
R¹—OC(O)O—R² (III)
wherein R¹ and R² represent an alkyl group respectively; the sum of carbon atoms in any of R¹ and R² is from 2 to 7; and at least one hydrogen in R¹ and/or R² is replaced by fluorine.

2. The lithium secondary battery according to claim 1, wherein 0.1≤x≤0.7.

3. The lithium secondary battery according to claim 1, wherein c is zero.

4. The lithium secondary battery according to claim 1, wherein a*(1−d)<[2x/(x+2)]+b*(1−d).

5. The lithium secondary battery according to claim 1, wherein the lithium transition metal oxide comprises Li_{1.09}Mn_{0.91}O₂, Li_{1.25}Mn_{0.625} Ni_{0.125}O₂, Li_{1.15}Mn_{0.56} Ni_{0.29}O₂ and Li_{1.17}Mn_{0.54}Ni_{0.28}O₂.

6. The lithium secondary battery according to claim 1, wherein R¹ and R² contain neither a CH₂F— group nor a —CHF— group.

7. The lithium secondary battery according to claim 1, wherein the fluorinated acyclic carbonate comprises CH₃—OC(O)O—CH₂CF₂H (methyl 2,2-difluoroethyl carbonate), CH₃—OC(O)O—CH₂CF₃ (methyl 2,2,2-trifluoroethyl carbonate), CH₃—OC(O)O—CH₂CF₂CF₂H (methyl 2,2,3,3-tetrafluoropropyl carbonate), CF₂HCH₂—OC(O)O—CH₂CF₃ (2,2-difluoroethyl 2,2,2-trifluoroethyl carbonate), CH₃CH₂—OC(O)O—CH₂CF₂H (ethyl 2,2-difluoroethyl carbonate), CF₃CH₂—OC(O)O—CH₂CH₃ (ethyl 2,2,2-trifluoroethyl carbonate), or mixtures thereof.

8. The lithium secondary battery according to claim 1, wherein the fluorinated acyclic carbonate is in an amount of from 10 to 50% by weight (wt %), preferably from 10 to 40 wt %, and more preferably from 10 to 30 wt %, based on the total weight of the liquid electrolyte.

9. The lithium secondary battery according to any of claim 1, wherein b) the liquid electrolyte further comprises at least one fluorinated acyclic carboxylic acid ester represented by the formula (IV)
R³—C(O)O—R⁴ (IV)
wherein R³ and R⁴ represent an alkyl group respectively; the sum of carbon atoms in R³ and R⁴ is from 2 to 7; and at least one hydrogen in R³ and/or R⁴ is replaced by fluorine.

10. The lithium secondary battery according to claim 1, wherein b) the liquid electrolyte further comprises at least one fluorinated acyclic diether represented by the formula (V)
R⁵—O—R⁶—O—R⁷ (V)
wherein R⁵ and R⁷ represent a fluorinated straight-chain alkyl group respectively; R⁶ represents an optionally fluorinated straight-chain alkyl group; and the sum of carbon atoms in R⁵, R⁶, and R⁷ is from 5 to 8.

11. The lithium secondary battery according to claim 1, wherein b) the liquid electrolyte further comprises at least one organic carbonate including a fluorinated cyclic carbonate, a non-fluorinated cyclic carbonate and a non-fluorinated acyclic carbonate, selected from the group consisting of 4-fluoroethylene carbonate (4-fluoro-1,3-dioxolan-2-one), 4,5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, 4-fluoromethyl-1,3-dioxolan-2-one, tetrafluoroethylene carbonate, 4-(2,2-difluoroethoxy)ethylene carbonate, 4-(2,2,2-trifluoroethoxy)ethylene carbonate, ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, dimethyl carbonate, ethyl methyl carbonate, diethyl carbonate, and mixtures thereof, in an amount of from 10 to 80 wt %, preferably from 20 to 60 wt % and more preferably from 25 to 50 wt %, based on the total weight of the liquid electrolyte.

12. The lithium secondary battery according to claim 1, wherein b) the liquid electrolyte further comprises at least one lithium salt selected from the group consisting of lithium hexafluorophosphate (LiPF₆), lithium perchlorate (LiClO₄), lithium hexafluoroarsenate (LiAsF₆), lithium hexafluoroantimonate (LiSbF₆), lithium hexafluorotantalate lithium (LiTaF₆), tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, LiBF₂[O₂C(CX₂)ₙCO₂], LiPF₂[O₂C(CX₂)ₙCO₂]₂, LiPF₄[O₂C(CX₂)ₙCO₂] wherein X is selected from the group consisting of H, F, Cl, C₁-C₄ alkyl groups and fluorinated alkyl groups, and n=0-4, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, or mixtures thereof.

13. The lithium secondary battery according to claim 1, wherein b) the liquid electrolyte further comprises at least one film-forming additive selected from the group consisting of sulfur compounds comprising 1,3,2-dioxathiolane-2,2-dioxide, 1,3,2-dioxathiane-2,2-dioxide, 1,3-propanesultone, ethylene sulphite and prop-1-ene-1,3-sultone; sulfone derivatives comprising dimethyl sulfone, tetramethylene sulfone (also known as sulfolane), ethyl methyl sulfone and isopropyl methyl sulfone; nitrile derivatives comprising succinonitrile, adiponitrile, and glutaronitirle; and lithium nitrate (LiNO₃); boron derivatives salt comprising lithium difluoro oxalato borate (LiDFOB), lithium bis(oxalato)borate (LiB(C₂O₄)₂; LiBOB), lithium fluoromalonato (difluoro)borate (LiB(O₂CCHFCO₂)₂; LiFMDFB), lithium bis(malonato)borate [LiB(O₂CCH₂CO₂)₂], lithium bis(difluoromalonato)borate [LiB(O₂CCF₂CO₂)₂], lithium (malonatooxalato) borate [LiB(C₂O₄)(O₂CCH₂CO₂)], lithium (difluoromalonatooxalato) borate [LiB(C₂O₄)(O₂CCF₂CO₂)], lithium tris(oxalato) phosphate [LiP(C₂O₄)₃], lithium tris(difluoromalonato)phosphate [LiP(O₂CCF₂CO₂)₃], lithium difluorophosphate (LiPO₂F₂), vinyl acetate, biphenyl benzene, isopropyl benzene, hexafluorobenzene, tris(trimethylsilyl)phosphate, triphenyl phosphine, ethyl diphenylphosphinite, triethyl phosphite, tris(2,2,2-trifluoroethyl) phosphite, maleic anhydride, cesium bis(trifluoromethanesulfonyl)imide (CsTFSI), cesium fluoride (CsF), and mixtures thereof.

14. A method comprising improving the cycling performance of a lithium secondary battery, wherein the lithium secondary battery comprises a liquid electrolyte comprising at least one fluorinated acyclic carbonate represented by the formula (III)
R¹—OC(O)O—R² (III)
wherein R¹ and R² represent an alkyl group respectively; the sum of carbon atoms in any of R¹ and R² is from 2 to 7; and at least one hydrogen in R¹ and/or R² is replaced by fluorine, and
a lithium transition metal oxide represented by the formula (I) as a cathode electroactive material
Li_{[(2x+2)/(x+2)]}Mn_{[2x/(x+2)]}M_{[(2-2x)/(x+2)]}O₂ (I)
wherein 0<x<1 and M is a combination of elements represented by the general formula (II)
(NiₐMn_{b}Co_{c})_{1-d}M′_{d} (II)
wherein a+b+c=1; 0≤c≤0.1; 0≤d≤0.1; and M′ comprises at least one metal selected from the group consisting of Sc, Ti, V, Cr, Fe, Cu, Zn, Mg, Al, Sn, B, Ga, Sr, Ca, In, Si, Zr, La, P, Nb, and Ge.

15. The method according to claim 14, wherein the fluorinated acyclic carbonate is CH₃—OC(O)O—CH₂CF₃ (methyl 2,2,2-trifluoroethyl carbonate).
